(19) United States
(12) Patent Application Publication
(10) Pub. No.: US 2025/0011686 A1
(43) Pub. Date: Jan. 9, 2025

(54) BIODEGRADABLE CHELATING AGENTS AND METHODS FOR FABRIC CARE

(71) Applicant: The Procter & Gamble Company, Cincinnati, OH (US)

(72) Inventors: Linsey Sarah FULLER, Newcastle Upon Tyne (GB); Robert William John STERRY, Newcastle upon Tyne (GB)

(21) Appl. No.: 18/741,887

(22) Filed: Jun. 13, 2024

Related U.S. Application Data
(60) Provisional application No. 63/524,260, filed on Jun. 30, 2023.

(51) Int. Cl. C11D 3/20; C11D 1/02; C11D 1/83

(52) U.S. Cl. CPC C11D 3/2034; C11D 1/02; C11D 1/83; C11D 3/2065; C11D 3/2096; C11D 2111/12

(57) ABSTRACT

Biodegradable chelating agents comprising tropolone, a derivate of tropolone, as well as combinations and salts thereof may be incorporated into a variety of fabric care compositions and delivery formats. The fabric care compositions may include at least one component, according to Formula 7, as well as combinations and salts thereof:

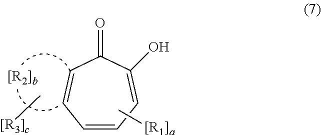

in which:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4.

### FIELD

The present disclosure relates generally to chelating agents and methods for using chelating agents and more specifically to biodegradable chelating agents and methods.

### BACKGROUND

The discussion of shortcomings and needs existing in the field prior to the present disclosure is in no way an admission that such shortcomings and needs were recognized by those skilled in the art prior to the present disclosure.

Phosphonate chelants may be employed in various fabric care compositions to improve stain removal. Phosphonate chelants may improve stain removal via heavy metal chelation; in this regard, useful phosphonate chelants tend to have a higher binding efficiency with iron (III) than with calcium. One such phosphonate chelant is 1-Hydroxyethylidene-1,1-diphosphonic acid (HEDP), also known as etidronic acid or etidronate, as shown in Formula 1.

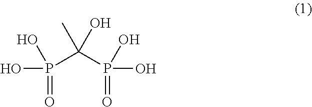

Another phosphonate chelant is diethylene triamine pentamethylene phosphonic acid (DTPMP) as shown in Formula 2.

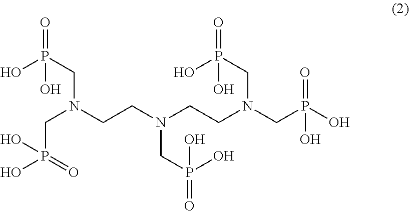 [SMILES: O=P(O)(O)CN(CCN(CP(=O)(O)O)CP(=O)(O)O)CCN(CP(=O)(O)O)CP(=O)(O)O]

Some phosphonate chelants are not readily biodegradable and may survive some wastewater treatments. Such phosphonate chelants may pose adverse effects to aquatic organisms. Therefore, a need exists to replace phosphonate chelants in various fabric care compositions with more biodegradable materials that preferably do not contain phosphorous.

Existing biodegradable replacements for phosphonate chelants include amino acid derivative complexing agents, as well as stereoisomers, and mixtures thereof. For example, methylglycinediacetic acid and salts thereof (MGDA), such as shown in Formula 3, has been used to replace phosphonate chelants.

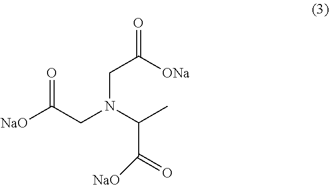

Similarly, L-glutamic acid, N,N-diacetic acid and salts thereof (GLDA) and salts thereof as shown in Formula 4, has been used to replace phosphonate chelants.

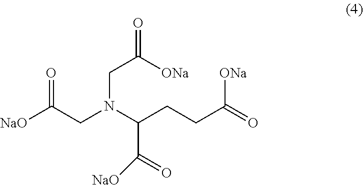

Unfortunately, neither MGDA nor GLDA match HEDP on stain removal performance. Therefore, a need still exists to replace phosphonate chelants in various fabric care compositions with more biodegradable materials that preferably do not contain phosphorous.

### SUMMARY

Various embodiments solve the above-mentioned problems and provide biodegradable chelating agents that may be incorporated into a variety of fabric care compositions and delivery formats and which provide similar or improved results compared to traditional chelating agents.

Various embodiments relate to solid detergent compositions comprising at least one component, according to Formula 7, as well as combinations and salts thereof:

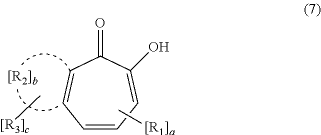

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4.
   Various embodiments relate single unit dose detergent comprising the solid detergent compositions. Various embodiments relate to methods for treating a stain on a fabric that comprise washing the fabric in a wash liquor comprising the solid detergent compositions. Various embodiments relate to the use of a solid detergent compositions to treat a stain on a fabric.

These and other features, aspects, and advantages of various embodiments will become better understood with reference to the following description, figures, and claims.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric. The terms “elevated temperatures” or “high-temperatures” generally refer to temperatures of at least 100° C.

“Average size” refers to the particle size. The particle size of a spherical object can be unambiguously and quantitatively defined by its diameter. However, a typical material object is likely to be irregular in shape and non-spherical. There are several ways of extending the above quantitative definition to apply to non-spherical particles. Existing definitions are based on replacing a given particle with an imaginary sphere that has one of the properties identical with the particle. Volume-based particle size equals the diameter of the sphere that has the same volume as a given particle. Area-based particle size equals the diameter of the sphere that has the same surface area as a given particle. Weight-based particle size equals the diameter of the sphere that has the same weight as a given particle. Hydrodynamic or aerodynamic particle size equals the diameter of the sphere that has the same drag coefficient as a given particle.

“Mixing” refers to a unit operation in industrial process engineering that involves manipulation of a heterogeneous physical system with the intent to make it more homogeneous. Mixing is performed to allow heat and/or mass transfer to occur between one or more streams, components, or phases.

“Disposed on” refers to a positional state indicating that one object or material is arranged in a position adjacent to the position of another object or material. The term does not require or exclude the presence of intervening objects, materials, or layers.

“Compositions” include fabric care compositions for handwash, machine wash and/or other purposes and include fabric care additive compositions and compositions suitable for use in the soaking and/or pretreatment of fabrics. They may take the form of, for example, laundry detergents, fabric pre-treatments, fabric conditioners and/or other wash, rinse, dryer added products, and sprays. Compositions in the liquid form may be in an aqueous carrier. Compositions in the liquid form may be in an aqueous carrier. In other aspects, the fabric care compositions are in the form of a granular detergent or dryer added fabric softener sheet. The term includes, unless otherwise indicated, granular or powder-form all-purpose or “heavy-duty” washing agents, especially cleaning detergents; liquid, gel or paste-form all-purpose washing agents, especially the so-called heavy-duty liquid (HDL) types; liquid fine-fabric detergents; cleaning auxiliaries such as bleach additives and “stain-stick” or pre-treat types, substrate-laden products, dry and wetted wipes and pads, nonwoven substrates, and sponges; and sprays and mists. Various dosage formats may be used. The composition may be provided in single unit dose (SUD) packets or pouches, including foil or plastic pouches or water soluble pouches, such as a polyvinyl alcohol (PVA) pouch; dosing balls or containers; containers with readily opened closures, such as pull tabs, screw caps, foil or plastic covers, and the like; or other container known in the art. The compositions may be compact compositions, comprising less than about 15%, or less than about 10%, or less than about 7% water.

“Unit dose” or “Single Unit Dose” means an amount of fabric care composition suitable to treat one load of laundry, such as from about 0.05 to about 100 g, or from 10 to about 60 g, or from about 20 to about 40 g.

“Liquid” includes free-flowing liquids, as well as pastes, gels, foams and mousses.

Non-limiting examples of liquids include light duty and heavy duty liquid detergent compositions, fabric enhancers, detergent gels commonly used for laundry, bleach and laundry additives. Gases, e.g., suspended bubbles, or solids, e.g. particles, may be included within the liquids.

“Solid” as used herein includes, but is not limited to, powders, agglomerates, and mixtures thereof. Non-limiting examples of solids include: granules, micro-capsules, beads, noodles, and pearlised balls. Solid compositions may provide a technical benefit including, but not limited to, through-the-wash benefits, pre-treatment benefits, and/or aesthetic effects.

It has unexpectedly been discovered that tropolone and derivatives thereof, such as hinokitiol are able to match or to exceed HEDP performance in stain removal for single unit dose (SUD) applications. Various embodiments, therefore, meet the need to replace phosphonate chelants in fabric care compositions with biodegradable materials that do not contain phosphorous.

Various embodiments relate to a chelating composition comprising tropolone, a tropolone derivative, as well as salts thereof. Tropolone is also known as 2-Hydroxycyclohepta-2,4,6-trien-1-one and is shown in Formula 5.

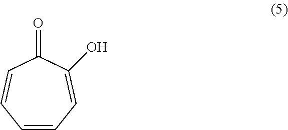

Hinokitiol is a tropolone derivative that is also known as 2-Hydroxy-6-(propan-2-yl)cyclohepta-2,4,6-trien-1-one, as shown in Formula 6.

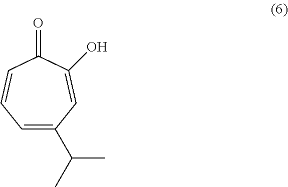

Various embodiments relate to a chelating composition comprising a component according to Formula 7

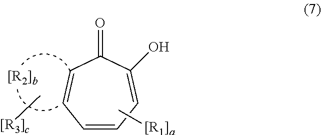

With respect to Formula 7,
R₁ may be hydroxyl, C₁-C₆ carboxyl, a linear or branched C₁-C₆ alkyl; a linear or branched C₂-C₆ alkenyl; or a linear or branched C₂-C₆ alkynyl group;
a may be from 0 to 5;
R₂ may be a fused C₁-C₆ cycloalkyl, a fused C₁-C₆ cycloalkoxy, or a fused C₁-C₆ cycloalkenyl;
b may be from 0 to 4;
R₃ may be oxygen, or hydroxyl; and
c may be from 0 to 4.
   It is to be appreciated that the component according to Formula 7 may be tropolone or hinokitiol. Formula 7 may represent tropolone when a, b, and c are 0. Formula 7 may represent hinokitiol when R₁ is a branched C₃ alkyl, a is 1, b is 0, and c is 0. The component according to Formula 7 may also be a variety of other compounds. For example, the component according to Formula 7 may be γ-Thujaplicin as shown in Formula 8.

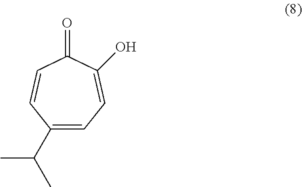

The component according to Formula 7 may be α-Thujaplicin as shown in Formula 9.

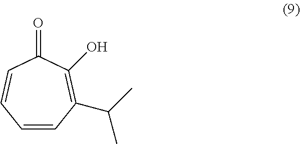

The component according to Formula 7 may be Purpurogallin as shown in Formula 10.

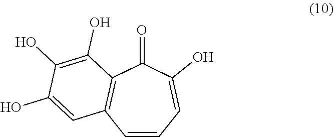 [SMILES: O=c1c(O)cccc2cc(O)c(O)c(O)c12]

The component according to Formula 7 may be Puberulic acid as shown in Formula 11.

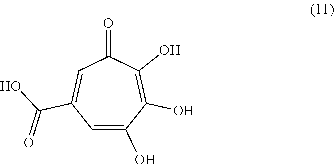 [SMILES: O=C(O)c1cc(O)c(O)c(O)c(=O)c1]

The component according to Formula 7 may be Puberulonic acid as shown in Formula 12.

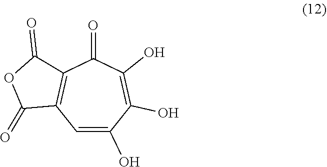 [SMILES: O=C1OC(=O)c2c1cc(O)c(O)c(O)c2=O]

Various embodiments relate to salts of tropolone or tropolone derivatives, and all components according to Formula 7, including but not limited to a sodium salts, potassium salts.

Chelation is a type of bonding of ions and molecules to metal ions. It involves the formation or presence of two or more separate coordinate bonds between a ligand and a metal atom. Without being bound by theory, the stain removal effectiveness of a composition comprising one or more chelating agents may depend at least in part on the ability of the chelating agent(s) to bind to iron, which may be present in some stains, such as fruit or beverage stains. Several factors may impact a chelating agent's ability to bind to iron. These factors may include the pKa of the chelating agent compared to the wash pH, and the affinity of the chelating agent to bind with other metals, materials, or compositions in the wash.

Various embodiments may provide or employ a composition that comprises one or more chelating agents having a pKa that is less than the wash pH. For example, according to various embodiments, the chelating agent(s) may have a pKa of about 8, of less than about 8, of about 7, of less than about 7, or in a range of from about 5 to about 7.

Various embodiments may provide or employ a composition that comprises one or more chelating agents exhibiting specific binding efficiencies with specific materials. The binding efficiencies may be expressed as a binding constant. A binding constant (also called formation constant or stability constant) is an equilibrium constant for the formation of a complex in solution. It is a measure of the strength of the interaction between the reagents that come together to form the complex. As an example, various stains may comprise catechins as shown in Formula 13.

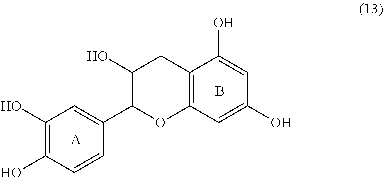

Such catechins may have a binding efficiency of about 3.5 with calcium and of about 19.2 with iron, as shown in Table 1, and are in competition with chelating agents to bind to these materials. The chelating agent(s) according to various embodiments may, therefore, be selected to ensure a lower binding efficiency with calcium and a higher binding efficiency with iron at the wash pH.

Various embodiments may provide or employ a composition that comprises one or more chelating agents having a calcium binding efficiency of about 2.0 to about 7.0, or about 2.2 to about 6.8, or about 2.5 to about 3.5, or about 2.7 to about 3.1, or less than about 6.8. A calcium binding efficiency of less than about 6.8, indicating that the chelating agent is less likely to bind to calcium than HEDP, as shown in Table 1.

Various embodiments may provide or employ a composition that comprises one or more chelating agents having an iron binding efficiency about 10 to about 20, or about 10.5 to about 14.1, or about 11 to about 12.9, greater than about 10, as shown in Table 1.

TABLE 1

| | Catechin | HEDP | Tropolone | Hinokitiol |
|---|---|---|---|---|
| pKa | 8.7 (A), 9.5 (B), | 1.7, 2.5, | 6.7 | about 7 |
| | 11.2(B), 13.4 (A) | 7.3, 10.3 | | |
| Ca²⁺ | 3.5 | 6.8 | 3.1 | 2.2 |
| logK(β₁₁₀) | | | | |
| Fe (III) | 19.2 | 14.1 | 10.5 | 12.9 |
| logK(β₁₁₀) | | | | |

In Table 1, the reaction between metals and ligands is described in terms of log K(β₁₁₀). In this context, K, is the equilibrium constant for the reaction between ligands and metals. The higher K, the more metal is bound. This is illustrated in the following example.

$${L H}_{6} + Fe {⇌}^{K} L Fe + 6 {H}^{+}$$

$$K = \frac{{[ L Fe ] [ {H}^{+} ]}^{6}}{[ {L H}_{6} ] [ Fe ]}$$

β, represents the binding efficiency and receives some subscripts (βₘₗₕ) to indicate how many metals (m), ligands (l), and protons (h) respectively are involved. Thus, β₁₁₀ indicates that one metal, one ligand, and no protons are involved.

### Solid Detergent Composition

Various embodiments relate to a solid detergent composition comprising at least one component according to Formula 7, combinations and salts thereof. The at least one component may be present in an amount of from greater than about 0 to about 10% by weight, or about 0.5 to about 9.5% by weight, or about 0.5 to about 9.5% by weight, or about 1.0 to about 9.0% by weight, or about 1.5 to about 8.5% by weight, or about 2.0 to about 8.0% by weight, or about 2.5 to about 7.5% by weight, or about 3.0 to about 7.0% by weight, or about 3.5 to about 6.5% by weight, or about 4.0 to about 6.0% by weight, or about 4.5 to about 5.5% by weight, or about 4.0 to about 5.0% by weight of the solid detergent composition.

It is to be appreciated that the solid detergent composition may comprise a variety of other components in addition to the at least one component according to Formula 7. For example, the solid detergent composition may include a surfactant. The solid detergent composition may be a laundry detergent composition. A solid “laundry detergent composition” may include any composition intended for the cleaning of fabric in a washing machine or in a hand wash context. The solid laundry detergent compositions may be used in high efficiency and standard washing machines, in addition to hand washing in a tub or basin for example. The detergent composition may be free of synthetic preservatives. Examples of synthetic preservatives include methylisothiazolinone and benzisothiazolinone.

### Solid Free-Flowing Particulate Laundry Detergent Composition

Typically, the solid free-flowing particulate laundry detergent composition is a fully formulated laundry detergent composition, not a portion thereof such as a spray-dried, extruded or agglomerate particle that only forms part of the laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

Suitable laundry detergent compositions may have a low buffering capacity. Such laundry detergent compositions typically have a reserve alkalinity to pH 9.5 of less than 5.0 gNaOH/100 g. These low buffered laundry detergent compositions typically comprise low levels of carbonate salt.

### Surfactant

The detergent composition may comprise from about 5% to about 75%, or about 5% to about 70%, or about 5% to about 65%, or about 5% to about 55%, or about 5% to about 50%, or about 10% to about 45%, or about 10% to about 40%, by weight of the detergent composition of a surfactant. The surfactant may be anionic, nonionic, amphoteric, zwitterionic, or a combination thereof.

Anionic surfactants may include, for example, alkylbenezene sulfonate, methyl ester sulfonate, alkyl ether carboxylate, alkyl sulfate, alkylalkoxylated sulfate, or a combination thereof. The alkyl benzene sulfonate may comprise a linear alkylbenzene sulphonate. Linear alkylbenzene sulfonate, may have a small amount of branched alkylbenzene sulfonate as a byproduct of the manufacturing process, but this will generally be less than about 5%. The linear alkylbenzene sulphonate may be present, for example, at a level of 0.5% to about 30%, by weight of the liquid detergent composition. The linear alkyl benzene sulphonate may be selected from, for example, alkyl benzene sulfonic acids, alkali metal or amine salts of C₁₀ to C₁₆ alkyl benzene sulfonic acids. In alkyl benzene sulfonic acids or alkali metal or amine salts of C₁₀ to C₁₆ alkyl benzene sulfonic acids, the linear alkyl benzene sulphonate surfactant can comprise greater than 50% C₁₂, greater than 60%, greater than 70% C₁₂, more preferably greater than 75%. The linear alkylbenzene sulphonate may comprise a C₁₀-C₁₆ alkyl benzene sulfonate, a C₁₁-C₁₄ alkyl benzene sulphonate, or a mixture thereof. The alkylbenzene sulphonate may be an amine neutralized alkylbenzene sulphonate, an alkali metal neutralized alkylbenzene sulphonate, or a mixture thereof. The amine comprises, for example, monoethanolamine, triethanolamine, monoisopropanolamine, or a mixture thereof. The alkali or alkali earth metal comprises, for example, sodium, potassium, magnesium, or a mixture thereof.

Another acceptable anionic surfactant comprises an alkyl sulphate anionic surfactant. The alkyl sulphate anionic surfactant may include, for example, alkyl sulphate, an alkoxylated alkyl sulphate, or a mixture thereof. The alkyl sulphate anionic surfactant may be a primary or a secondary alkyl sulphate anionic surfactant, or a mixture thereof, for example sodium lauryl sulfate. The alkoxylated alkyl sulphate may comprise an ethoxylated alkyl sulphate, propoxylated alkyl sulphate, a mixed ethoxylated/propoxylated alkyl sulphate, or a mixture thereof. An ethoxylated alkyl sulphate may have an average degree of ethoxylation of between 0.1 to 5, or between 0.5 and 3. The ethoxylated alkyl sulphate may have an average alkyl chain length of between 8 and 18, more preferably between 10 and 16, most preferably between 12 and 15. The alkyl portion of the ethoxylated alkyl sulphate may include, on average, from 13.7 to about 16 or from 13.9 to 14.6 carbons atoms. At least about 50% or at least about 60% of the AES molecule may include having an alkyl portion having 14 or more carbon atoms, from 14 to 18, or from 14 to 17, or from 14 to 16, or from 14 to 15 carbon atoms.

The alkyl ether carboxylate may be linear or branched. It may have an average carbon chain length of about 10 to about 26, about 10 to about 20, or about 16 to about 18. The alkyl ether carboxylate may have an average level of ethoxylation of about 2 to about 20, about 7 to about 13, about 8 to about 12, or about 9.5 to about 10.5. The acid form or salt form may be used. The alkyl chain may contain one cis or trans double bond. Commercial alkyl ether carboxylates are available, for example, from Kao (Akypo®), Huntsman (Empicol®), and Clariant (Emulsogen®).

The alkyl chain of the alkyl sulphate anionic surfactant may be linear, branched or a mixture thereof. A branched alkyl sulphate anionic surfactant may be a branched primary alkyl sulphate, a branched secondary alkyl sulphate, or a mixture thereof, preferably a branched primary alkyl sulphate, wherein the branching preferably is in the 2-position, or alternatively might be present further down the alkyl chain or could be multi-branched with branches spread over the alkyl chain. The weight average degree of branching of alkyl sulphate anionic surfactant may be from 0% to 100% preferably from 0% to 95%, more preferably from 0% to 60%, most preferably from 0% to 20%. Alternatively, the weight average degree of branching of alkyl sulphate anionic surfactant may be from 70% to 100%, preferably from 80% to 90%. Preferably, the alkyl chain is selected from naturally derived material, synthetically derived material, or a mixture thereof. Preferably, the synthetically derived material comprises oxo-synthesized material, Ziegler-synthesized material, Guerbet-synthesized material, Fischer-Tropsch—synthesized material, iso-alkyl synthesized material, or mixtures thereof, preferably oxo-synthesized material.

Branched 2-alkyl primary alkyl alcohol sulfates and 2-alkyl primary alkyl alcohol ethoxy sulfates having specific alkyl chain length distributions, may provide increased stain removal (particularly in cold water). 2-alkyl branched alcohols (and the 2-alkyl branched alkyl sulfates and 2-alkyl branched alkyl ethoxy sulfates and other surfactants derived from them) are positional isomers, where the location of the hydroxymethyl group (consisting of a methylene bridge (—CH₂— unit) connected to a hydroxy (—OH) group) on the carbon chain varies. Thus, a 2-alkyl branched alkyl alcohol is generally composed of a mixture of positional isomers. Furthermore, it is well known that fatty alcohols, such as 2-alkyl branched alcohols, and surfactants are characterized by chain length distributions. In other words, fatty alcohols and surfactants are generally made up of a blend of molecules having different alkyl chain lengths (though it is possible to obtain single chain-length cuts). Notably, the 2-alkyl primary alcohols described herein, which may have specific alkyl chain length distributions and/or specific fractions of certain positional isomers, cannot be obtained by simply blending commercially available materials. Specifically, the distribution of from about 50% to about 100% by weight surfactants having m+n=11 is not achievable by blending commercially available materials.

The detergent composition may comprise a mixture of surfactant isomers of Formula 14 and surfactants of Formula 15:

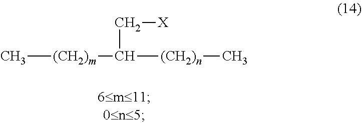

CH₃—(CH₂)ₘ₊ₙ₊₃—X (15)

wherein from about 50% to about 100% by weight of the first surfactant are isomers having m+n=11; wherein from about 25% to about 50% of the mixture of surfactant isomers of Formula 14 have n=0; wherein from about 0.001% to about 25% by weight of the first surfactant are surfactants of Formula 15; and wherein X is a hydrophilic moiety.

X may be, for example, neutralized with sodium hydroxide, potassium hydroxide, magnesium hydroxide, lithium hydroxide, calcium hydroxide, ammonium hydroxide, monoethanolamine, diethanolamine, triethanolamine, monoisopropanolamine, diamine, polyamine, primary amine, secondary amine, tertiary amine, amine containing surfactant, or a combination thereof.

X may be selected from sulfates, alkoxylated alkyl sulfates, sulfonates, amine oxides, polyalkoxylates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkyated/polyhydroxyalkylated quats, alkylated/polyhydroxylated oxypropyl quats, imidazolines, 2-yl-succinates, sulfonated alkyl esters, sulfonated fatty acids, and mixtures thereof.

The anionic surfactant may also be a biosurfactant. Anionic biosurfactants may include, for example, rhamnolipids. The rhamnolipid may have a single rhamnose sugar ring or two sugar rings.

The detergent composition may also comprise a non-ionic surfactant. A nonionic surfactant may comprise an alcohol alkoxylate, an oxo-synthesized alcohol alkoxylate, a Guerbet alcohol alkoxylate, an alkyl phenol alcohol alkoxylate, an alkylpolyglucoside, or a mixture thereof. Preferably, a non-ionic surfactant may include, for example, alkoxylated alcohol nonionic surfactants, alkyl polyglucoside nonionic surfactants, and mixtures thereof. Preferably, the alkoxylated alcohol non-ionic surfactant is a linear or branched, primary or secondary alkyl alkoxylated non-ionic surfactant, preferably an alkyl alkoxylated non-ionic surfactant, preferably an alkyl ethoxylated nonionic surfactant, preferably comprising on average from about 9 to about 15, preferably from about 10 to about 16, more preferably from about 12 to about 15, carbon atoms in its alkyl chain; and on average from about 5 to about 12, preferably from about 6 to about 10, most preferably from about 7 to about 8 or from about 9 to about 10, units of ethylene oxide per mole of alcohol. For example, a nonionic surfactant can comprises an ethoxylated nonionic surfactant wherein the ethoxylated nonionic surfactant with an average carbon chain length of about 10 to about 16 comprises an ethoxylated nonionic surfactant with an average carbon chain length of about 12 to about 14 and an average level of ethoxylation of about 9 and a second ethoxylated nonionic surfactant with an average carbon chain length of about 14 to about 15 and an average ethoxylation of about 7.

The nonionic surfactant may have the formula R(OC₂H₄)ₙOH, wherein R is selected from the group consisting of aliphatic hydrocarbon radicals containing from about 8 to about 16 carbon atoms and can be linear or branched and the average value of n is from about 5 to about 15. For example, the additional nonionic surfactant may be selected from ethoxylated alcohols having an average of about 12-14 carbon atoms in the alcohol (alkyl) portion and an average degree of ethoxylation of about 7-9 moles of ethylene oxide per mole of alcohol.

Additional non limiting examples include ethoxylated alkyl phenols of the formula R(OC₂H₄)ₙOH, wherein R comprises an alkyl phenyl radicals in which the alkyl groups contain from about 8 to about 12 carbon atoms, and the average value of n is from about 5 to about 15, C₁₂-C₁₈ alkyl ethoxylates, such as, NEODOL® nonionic surfactants from Shell; C₁₄-C₂₂ mid-chain branched alcohols; C₁₄-C₂₂ mid-chain branched alkyl ethoxylates, BAEₓ, wherein x is from 1 to 30. The nonionic ethoxylated alcohol surfactant herein may further comprise residual alkoxylation catalyst, which may be considered residue from the reaction or an impurity. It may further comprise various impurities or by-products of the alkoxylation reaction. The impurities may vary depending on the catalyst used and the conditions of the reaction. Impurities include alkyl ethers, e.g., dialkyl ethers, such as, didodecyl ether, glycols, e.g., diethylene glycol, triethylene glycol, pentaethylene glycol, other polyethylene glycols.

The nonionic ethoxylated alcohol may be a narrow range ethoxylated alcohol. A narrow range ethoxylated alcohol may have the following general formula (I):

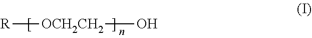

where R is selected from a saturated or unsaturated, linear or branched, C₁₀-C₁₆ alkyl group and where greater than 90% of n is 0≤n≤15. In addition, the average value of n can be between about 4 to about 14, preferably about 6 to about 10, where less than about 10% by weight of the alcohol ethoxylate are ethoxylates having n<7 and between 10% and about 20% by weight of the alcohol ethoxylate are ethoxylates having n=8.

The composition may comprise an average value of n of about 10. The composition may have the following ranges for each of the following n: n=0 of up to 5%, each of n=1, 2, 3, 4, 5 of up to 2%, n=6 of up to 4%, n=7 of up to 10%, n=8 of between 12% and 20%, n=9 of between 15% and 25%, n=10 of between 15% to 30%, n=11 of between 10% and 20%, n=12 of up to 10%, and n>12 at up to 10%. The composition may have n=9 to 10 of between 30% and 70%. The composition may have greater than 50% of its composition made up of n=8 to 11.

R can be selected from a saturated or unsaturated, linear or branched, C10-C16 alkyl group, where the average value of n is between about 6 and about 10. R can also be selected from a saturated or unsaturated, linear or branched, C₈-C₁₆ alkyl group, where greater than 90% of n is 0≤n≤15, and where the average value of n between about 5 to about 10, where less than about 20% by weight of the alcohol ethoxylate are ethoxylates having n<8. R can also be selected from a saturated or unsaturated, linear or branched, C₁₀-C₁₆ alkyl group, where greater than 90% of n is 0≤n≤15, and where the average value of n between about 6 to about 10, where less than about 10% by weight of the alcohol ethoxylate are ethoxylates having n<7 and between 10% and about 20% by weight of the alcohol ethoxylate are ethoxylates having n=8.

The alcohol ethoxylates described herein are typically not single compounds as suggested by their general formula (I), but rather, they comprise a mixture of several homologs having varied polyalkylene oxide chain length and molecular weight. Among the homologs, those with the number of total alkylene oxide units per mole of alcohol closer to the most prevalent alkylene oxide adduct are desirable; homologs whose number of total alkylene oxide units is much lower or much higher than the most prevalent alkylene oxide adduct are less desirable. In other words, a “narrow range” or “peaked” alkoxylated alcohol composition is desirable. A “narrow range” or “peaked” alkoxylated alcohol composition refers to an alkoxylated alcohol composition having a narrow distribution of alkylene oxide addition moles.

A “narrow range” or “peaked” alkoxylated alcohol composition may be desirable for a selected application. Homologs in the selected target distribution range may have the proper lipophilic-hydrophilic balance for a selected application. For example, in the case of an ethoxylated alcohol product comprising an average ratio of 5 ethylene oxide (EO) units per molecule, homologs having a desired lipophilic-hydrophilic balance may range from 2EO to 9EO. Homologs with shorter EO chain length (<2EO) or longer EO chain length (>9EO) may not be desirable for the applications for which a=5 EO/alcohol ratio surfactant is ordinarily selected since such longer and shorter homologs are either too lipophilic or too hydrophilic for the applications utilizing this product. Therefore, it is advantageous to develop an alkoxylated alcohol having a peaked distribution.

The narrow range alkoxylated alcohol compositions of the disclosure may have an average degree of ethoxylation ranging from about 0 to about 15, such as, for example, ranging from about 4 to about 14, from about 5-10, from about 8-11, and from about 6-9. The narrow range alkoxylated alcohol compositions of the disclosure may have an average degree of ethoxylation of 10. The narrow range alkoxylated alcohol compositions of the disclosure may have an average degree of ethoxylation of 9. The narrow range alkoxylated alcohol compositions of the disclosure may have an average degree of ethoxylation of 5.

The alkyl polyglucoside surfactant can be selected from C10-C16 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C10-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

The detergent composition may also comprise an amphoteric surfactant and/or zwitterionic surfactant. Suitable amphoteric or zwitterionic surfactants include amine oxides, and/or betaines. Preferred amine oxides are alkyl dimethyl amine oxide or alkyl amidopropyl dimethyl amine oxide, more preferably alkyl dimethyl amine oxide and especially coco dimethyl amine oxide. Amine oxide may have a linear or mid-branched alkyl moiety. Typical linear amine oxides include water-soluble amine oxides containing one R₄ C₈ to C₁₈ alkyl moiety and 2 R₅ and R₆ moieties selected from the group consisting of C₁ to C₃ alkyl groups and C₁ to C₃ hydroxyalkyl groups. Preferably amine oxide is characterized by Formula 16

R₄—N(R₅)(R₆)O (16)

in which R₄ is a C₈ to C₁₈ alkyl and R₅ and R₆ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides.

Other suitable surfactants include betaines, such as alkyl betaines, alkylamidobetaine, amidazoliniumbetaine, sulfobetaine (sultaines) as well as phosphobetaines, or a combination thereof.

### Polymer

Suitable polymers include carboxylate polymers, soil release polymers, anti-redeposition polymers, cellulosic polymers, care polymers and any combination thereof.

### Carboxylate Polymer

The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

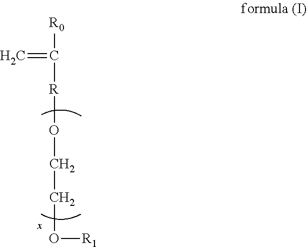

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

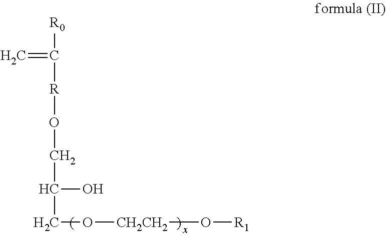

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.
It may be preferred that the polymer has a weight average molecular weight of at least 50 kDa, or even at least 70 kDa.

### Soil Release Polymer

The composition may comprise a soil release polymer. A suitable soil release polymer has a structure as defined by one of the following structures (I), (II) or (III):

[(OCHR¹—CHR²)ₐ—O—OC—Ar—CO-]_{d} (I)

—[(OCHR³—CHR⁴)_{b}—O—OC-sAr—CO-]ₑ (II)

[(OCHR⁵—CHR⁶)_{c}—OR⁷]_{f} (III)

wherein:
a, b and c are from 1 to 200;
d, e and f are from 1 to 50; Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.
   Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

### Anti-Redeposition Polymer

Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO08/007320.

A suitable polyethylene glycol polymer is Sokalan HP22.

### Cellulosic Polymer

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

### Care Polymers

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

### Bleach

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

### Source of Hydrogen Peroxide

Suitable sources of hydrogen peroxide include sodium perborate and/or sodium percarbonate.

### Bleach Activator

Suitable bleach activators include tetra acetyl ethylene diamine and/or alkyl oxybenzene sulphonate.

### Bleach Catalyst

The composition may comprise a bleach catalyst. Suitable bleach catalysts include oxaziridinium bleach catalysts, transition metal bleach catalysts, especially manganese and iron bleach catalysts. A suitable bleach catalyst has a structure corresponding to general formula below:

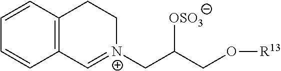

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

### Pre-Formed Peracid

Suitable pre-form peracids include phthalimido-peroxycaproic acid.

### Enzymes

Suitable enzymes include lipases, proteases, cellulases, amylases and any combination thereof.

### Protease

Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V1041+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

A suitable protease is described in WO11/140316 and WO11/072117.

### Amylase

Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

A suitable amylase is described in WO06/002643.

### Cellulase

Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO07/144857 and WO10/056652.

### Lipase

Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO06/090335 and WO13/116261. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable lipases include: Liprl 139, e.g. as described in WO2013/171241; and TfuLip2, e.g. as described in WO2011/084412 and WO2013/033318.

### Other Enzymes

Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

### Zeolite Builder

The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

### Phosphate Builder

The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

### Carbonate Salt

The composition may comprise carbonate salt. The composition may comprise from 0 wt % to 10 wt % carbonate salt, or to 5 wt % carbonate salt. The composition may even be substantially free of carbonate salt; substantially free means “no deliberately added”. Suitable carbonate salts include sodium carbonate and sodium bicarbonate.

### Silicate Salt

The composition may comprise silicate salt. The composition may comprise from 0 wt % to 10 wt % silicate salt, or to 5 wt % silicate salt. A preferred silicate salt is sodium silicate, especially preferred are sodium silicates having a Na₂O:SiO₂ ratio of from 1.0 to 2.8, preferably from 1.6 to 2.0.

### Sulphate Salt

A suitable sulphate salt is sodium sulphate.

### Brightener

Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)];amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.

### Other Chelants

The composition may also comprise one or more additional chelants, i.e., other than the chelating compounds according to Formula 7, selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

### Hueing Agent

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents described in WO2014/089386.

Suitable hueing agents include phthalocyanine and azo dye conjugates, such as described in WO2009/069077.

Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, such as described in WO2012/054835, and/or alkoxylated thiophene azo dyes, such as described in WO2008/087497 and WO2012/166768.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles, such as described in WO 2009/069077.

### Dye Transfer Inhibitors

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP—K15 and K30 (Ashland), Sokalan® HP165, HP50, HP53, HP59, HP56K, HP56, HP66 (BASF), Chromabond® S-400, S403E and S-100 (Ashland).

### Perfume

Suitable perfumes comprise perfume materials selected from the group: (a) perfume materials having a C log P of less than 3.0 and a boiling point of less than 250° C. (quadrant 1 perfume materials); (b) perfume materials having a C log P of less than 3.0 and a boiling point of 250° C. or greater (quadrant 2 perfume materials); (c) perfume materials having a C log P of 3.0 or greater and a boiling point of less than 250° C. (quadrant 3 perfume materials); (d) perfume materials having a C log P of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO2009/101593.

### Silicone

Suitable silicones include polydimethylsiloxane and amino-silicones. Suitable silicones are described in WO05075616.

### Process for Making the Solid Composition

Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower, such as described in WO2009/158162.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449.

It may be preferred for a gas, such as air, to be introduced into the spray-drying process after the step of forming the aqueous slurry, such as described in WO2013/181205.

It may be preferred for any inorganic ingredients, such as sodium sulphate and sodium carbonate, if present in the aqueous slurry mixture, to be micronized to a small particle size such as described in WO2012/134969.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

### Adjuncts

Compositions according to various embodiments may comprise on or more adjunct ingredient(s). The non-limiting list of adjuncts provided hereinafter are suitable for use in the instant compositions and may be desirably incorporated in certain embodiments, for example to assist or enhance performance, for treatment of the substrate to be cleaned, or to modify the aesthetics of the composition as is the case with perfumes, colorants, dyes or the like. Suitable adjunct materials include, but are not limited to, polymers, for example cationic polymers, surfactants, builders, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments.

### Method of Laundering Fabric

The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### Fibrous Water Soluble Products

The composition according to any embodiment described herein may be delivered via or in the form of a fibrous water soluble product. A fibrous water soluble product can include one or more layers. These layers may be superposed upon one another. The layers may lay directly upon one another, have particles in between the layers, or combination thereof.

The fibrous water-soluble unit dose article may comprise of 50% or greater of bio-based materials, such as for example between 50% and 95% bio-based. Some of the individual components of the fibrous water-soluble unit dose article may be fully bio-based to create an article that has a total bio-based content of greater than 50%.

These fibrous water-soluble unit dose articles can be dissolved under various wash conditions, e.g., low temperature, low water and/or short wash cycles or cycles where consumers have been overloading the machine, especially with items having high water absorption capacities, while providing sufficient delivery of active agents for the intended effect on the target consumer substrates (with similar performance as today's liquid products).

The surface of the fibrous water-soluble unit dose article may comprise a printed area. The printed area may cover between about 10% and about 100% of the surface of the article. The area of print may comprise inks, pigments, dyes, bluing agents or mixtures thereof. The area of print may be opaque, translucent or transparent. The area of print may comprise a single color or multiple colors. The printed area maybe on more than one side of the article and contain instructional text, graphics, etc. The surface of the water-soluble unit dose article may comprise an aversive agent, for example a bittering agent. Suitable bittering agents include, but are not limited to, naringin, sucrose octacetate, quinine hydrochloride, denatonium benzoate, or mixtures thereof. Any suitable level of aversive agent may be used. Suitable levels include, but are not limited to, 1 to 5000 ppm, or even 100 to 2500 ppm, or even 250 to 2000 ppm.

The fibrous water-soluble unit dose articles may exhibit a thickness of greater than 0.01 mm and/or greater than 0.05 mm and/or greater than 0.1 mm and/or to about 100 mm and/or to about 50 mm and/or to about 20 mm and/or to about 10 mm and/or to about 5 mm and/or to about 2 mm and/or to about 0.5 mm and/or to about 0.3 mm.

The fibrous water-soluble unit dose articles may have basis weights of from about 500 grams/m² to about 5,000 grams/m², or from about 1,000 grams/m² to about 4,000 grams/m², or from about 1,500 grams/m² to about 3,500 grams/m², or from about 2,000 grams/m² to about 3,000 grams/m², or any combination thereof.

The fibrous water-soluble unit dose article may exhibit different regions, such as different regions of basis weight, density, caliper, and/or wetting characteristics. The fibrous water-soluble unit dose article may be compressed at the point of edge sealing. The fibrous water-soluble unit dose article may comprise texture on one or more of its surfaces. A surface of the fibrous water-soluble unit dose article may comprise a pattern, such as a non-random, repeating pattern. The fibrous water-soluble unit dose article may comprise apertures. The fibrous water-soluble unit dose article may comprise a fibrous structure having discrete regions of fibrous elements that differ from other regions of fibrous elements in the structure. The fibrous water-soluble unit dose article may be used as is or it may be coated with one or more active agents.

The fibrous water-soluble unit dose article may comprise one or more plies. The fibrous water-soluble unit dose article may comprise at least two and/or at least three and/or at least four and/or at least five plies. The fibrous plies can be fibrous structures. Each ply may comprise one or more layers, for example one or more fibrous element layers, one or more particle layers, and/or one or more fibrous element/particle mixture layers. The layer(s) may be sealed. In particular, particle layers and fibrous element/particle mixture layers may be sealed, such that the particles do not leak out. The water-soluble unit dose articles may comprise multiple plies, where each ply comprises two layers, where one layer is a fibrous element layer and one layer is a fibrous element/particle mixture layer, and where the multiple plies are sealed (e.g., at the edges) together. Sealing may inhibit the leakage of particles as well as help the unit dose article maintain its original structure. However, upon addition of the water-soluble unit dose article to water, the unit dose article dissolves and releases the particles into the wash liquor.

The fibrous water-soluble unit dose may be in the form of any three-dimensional structure. The fibrous water-soluble unit dose article can be perforated. The article can also be cut or shaped into various sizes for different intended uses. For example, the water-soluble unit dose may be in the form of a square, a rounded square, a kite, a rectangle, a triangle, a circle, an ellipse, and mixtures thereof.

The fibrous water-soluble unit dose may comprise less than 10 ingredients. The water-soluble unit dose may comprise between 3 and 9 ingredients, such as, for example, 4 ingredients, 5 ingredients, 6 ingredients, 7 ingredients, or 8 ingredients.

The fibrous water-soluble unit dose articles disclosed herein comprise a water-soluble fibrous structure and one or more particles. The fibrous water-soluble fibrous structure may comprise a plurality of fibrous elements, for example a plurality of filaments. The one or more particles, for example one or more active agent-containing particles, may be distributed throughout the structure. The fibrous water-soluble unit dose article may comprise a plurality of two or more and/or three or more fibrous elements that are inter-entangled or otherwise associated with one another to form a fibrous structure and one or more particles, which may be distributed throughout the fibrous structure.

The fibrous water-soluble unit dose article may comprise a water-soluble fibrous structure. The water-soluble fibrous structure may comprise two or more different fibrous elements. Non-limiting examples of differences in the fibrous elements may be physical differences, such as differences in diameter, length, texture, shape, rigidness, elasticity, and the like; chemical differences, such as crosslinking level, solubility, melting point, Tg, active agent, filament-forming material, color, level of active agent, basis weight, level of filament-forming material, presence of any coating on fibrous element, biodegradable or not, hydrophobic or not, contact angle, and the like; differences in whether the fibrous element loses its physical structure when the fibrous element is exposed to conditions of intended use; differences in whether the fibrous element's morphology changes when the fibrous element is exposed to conditions of intended use; and differences in rate at which the fibrous element releases one or more of its active agents when the fibrous element is exposed to conditions of intended use. Two or more fibrous elements within the fibrous structure may comprise different active agents. This may be the case where the different active agents may be incompatible with one another, for example an anionic surfactant and a cationic polymer. When using different fibrous elements, the resulting structure may exhibit different wetting, imbibition, and solubility characteristics.

### Fibrous Structure

Fibrous structures comprise one or more fibrous elements. The fibrous elements can be associated with one another to form a structure. Fibrous structures can include particles within and or on the structure. Fibrous structures can be homogeneous, layered, unitary, zoned, or as otherwise desired, with different active agents defining the various aforesaid portions.

A fibrous structure can comprise one or more layers, the layers together forming a ply.

### Fibrous Elements

The fibrous elements may be water-soluble. The fibrous elements may comprise one or more filament-forming materials and/or one or more active agents, such as a surfactant described above. The one or more active agents may be releasable from the fibrous element, such as when the fibrous element and/or fibrous structure comprising the fibrous element is exposed to conditions of intended use.

The fibrous elements may be spun from a filament-forming composition, also referred to as fibrous element-forming compositions, via suitable spinning process operations, such as meltblowing, spunbonding, electro-spinning, and/or rotary spinning.

“Filament-forming composition” and/or “fibrous element-forming composition” as used herein means a composition that is suitable for making a fibrous element such as by meltblowing and/or spunbonding. The filament-forming composition comprises one or more filament-forming materials that exhibit properties that make them suitable for spinning into a fibrous element. The filament-forming material may comprise a polymer. In addition to one or more filament-forming materials, the filament-forming composition may comprise one or more active agents, for example, a surfactant. In addition, the filament-forming composition may comprise one or more polar solvents, such as water, into which one or more, for example all, of the filament-forming materials and/or one or more, for example all, of the active agents are dissolved and/or dispersed prior to spinning a fibrous element, such as a filament from the filament-forming composition.

The filament-forming composition may comprise two or more different filament-forming materials. Thus, the fibrous elements may be monocomponent (one type of filament-forming material) and/or multicomponent, such as bicomponent. The two or more different filament-forming materials may be randomly combined to form a fibrous element. The two or more different filament-forming materials may be orderly combined to form a fibrous element, such as a core and sheath bicomponent fibrous element, which is not considered a random mixture of different filament-forming materials for purposes of the present disclosure. Bicomponent fibrous elements may be in any form, such as side-by-side, core and sheath, islands-in-the-sea and the like.

The fibrous elements may be substantially free of alkylalkoxylated sulfate. Each fibrous element may comprise from about 0%, or from about 0.1%, or from about 5%, or from about 10%, or from about 15%, or from about 20%, or from about 25%, or from about 30%, or from about 35%, or from about 40% to about 0.2%, or to about 1%, or to about 5%, or to about 10%, or to about 15%, or to about 20%, or to about 25%, or to about 30%, or to about 35% or to about 40%, or to about 50% by weight on a dry fibrous element basis of an alkylalkoxylated sulfate. The amount of alkylalkoxylated sulfate in each of the fibrous elements is sufficiently small so as not to affect the processing stability and film dissolution thereof. Alkylalkoxylated sulfates, when dissolved in water, may undergo a highly viscous hexagonal phase at certain concentration ranges, e.g., 30-60% by weight, resulting in a gel-like substance. Therefore, if incorporated into the fibrous elements in a significant amount, alkylalkoxylated sulfates may significantly slow down the dissolution of the water-soluble unit dose articles in water, and worse yet, result in undissolved solids afterwards. Correspondingly, most of such surfactants are formulated into the particles.

The fibrous elements may each contain at least one filament-forming material and an active agent, preferably a surfactant. The surfactant may have a relatively low hydrophilicity, as such a surfactant is less likely to form a viscous, gel-like hexagonal phase when being diluted. By using such a surfactant in forming the filaments, gel-formation during wash may be effectively reduced, which in turn may result in faster dissolution and low or no residues in the wash. The surfactant can be selected, for example, from the group consisting of unalkoxylated C₆-C₂₀ linear or branched alkyl sulfates (AS), C₆-C₂₀ linear alkylbenzene sulfonates (LAS), and combinations thereof. The surfactant may be a C₆-C₂₀ linear alkylbenzene sulfonates (LAS). LAS surfactants are well known in the art and can be readily obtained by sulfonating commercially available linear alkylbenzenes. Exemplary C₆-C₂₀ linear alkylbenzene sulfonates that can be used include alkali metal, alkaline earth metal or ammonium salts of C₆-C₂₀ linear alkylbenzene sulfonic acids, such as the sodium, potassium, magnesium and/or ammonium salts of C₁₁-C₁₈ or C₁₁-C₁₄ linear alkylbenzene sulfonic acids. The sodium or potassium salts of C₁₂ linear alkylbenzene sulfonic acids, for example, the sodium salt of C₁₂ linear alkylbenzene sulfonic acid, i.e., sodium dodecylbenzene sulfonate, may be used as the first surfactant.

The fibrous element may comprise at least about 5%, and/or at least about 10%, and/or at least about 15%, and/or at least about 20%, and/or less than about 80%, and/or less than about 75%, and/or less than about 65%, and/or less than about 60%, and/or less than about 55%, and/or less than about 50%, and/or less than about 45%, and/or less than about 40%, and/or less than about 35%, and/or less than about 30%, and/or less than about 25% by weight on a dry fibrous element basis and/or dry fibrous structure basis of the filament-forming material and greater than about 20%, and/or at least about 35%, and/or at least about 40%, and/or at least about 45%, and/or at least about 50%, and/or at least about 55%, and/or at least about 60%, and/or at least about 65%, and/or at least about 70%, and/or less than about 95%, and/or less than about 90%, and/or less than about 85%, and/or less than about 80%, and/or less than about 75% by weight on a dry fibrous element basis and/or dry fibrous structure basis of an active agent, preferably surfactant. The fibrous element may comprise greater than about 80% by weight on a dry fibrous element basis and/or dry fibrous structure basis of surfactant.

Preferably, each fibrous element may be characterized by a sufficiently high total surfactant content, e.g., at least about 30%, or at least about 40%, or at least about 50%, or at least about 60%, or at least about 70%, by weight on a dry fibrous element basis and/or dry fibrous structure basis of the first surfactant.

The total level of filament-forming materials present in the fibrous element may be from about 5% to less than about 80% by weight on a dry fibrous element basis and/or dry fibrous structure basis and the total level of surfactant present in the fibrous element may be greater than about 20% to about 95% by weight on a dry fibrous element basis and/or dry fibrous structure basis.

In general, fibrous elements are elongated particulates having a length greatly exceeding average diameter, e.g., a length to average diameter ratio of at least about 10. A fibrous element may be a filament or a fiber. Filaments are relatively longer than fibers. A filament may have a length of greater than or equal to about 5.08 cm (2 in.), and/or greater than or equal to about 7.62 cm (3 in.), and/or greater than or equal to about 10.16 cm (4 in.), and/or greater than or equal to about 15.24 cm (6 in.). A fiber may have a length of less than about 5.08 cm (2 in.), and/or less than about 3.81 cm (1.5 in.), and/or less than about 2.54 cm (1 in.).

The one or more filament-forming materials and active agents may be present in the fibrous element at a weight ratio of total level of filament-forming materials to active agents of about 2.0 or less, and/or about 1.85 or less, and/or less than about 1.7, and/or less than about 1.6, and/or less than about 1.5, and/or less than about 1.3, and/or less than about 1.2, and/or less than about 1, and/or less than about 0.7, and/or less than about 0.5, and/or less than about 0.4, and/or less than about 0.3, and/or greater than about 0.1, and/or greater than about 0.15, and/or greater than about 0.2. The one or more filament-forming materials and active agents may be present in the fibrous element at a weight ratio of total level of filament-forming materials to active agents of about 0.2 to about 0.7.

The fibrous element may comprise from about 10% to less than about 80% by weight on a dry fibrous element basis and/or dry fibrous structure basis of a filament-forming material, such as polyvinyl alcohol polymer, starch polymer, and/or carboxymethylcellulose polymer, and greater than about 20% to about 90% by weight on a dry fibrous element basis and/or dry fibrous structure basis of an active agent, such as surfactant. The fibrous element may further comprise a plasticizer, such as glycerin, and/or additional pH adjusting agents, such as citric acid. The fibrous element may have a weight ratio of filament-forming material to active agent of about 2.0 or less. The filament-forming material may be selected from the group consisting of polyvinyl alcohol, starch, carboxymethylcellulose, polyethylene oxide, and other suitable polymers, especially hydroxyl-containing polymers and their derivatives. The filament-forming material may range in weight average molecular weight from about 100,000 g/mol to about 3,000,000 g/mol. It is believed that in this range, the filament-forming material may provide extensional rheology, without being so elastic that fiber attenuation is inhibited in the fiber-making process.

The one or more active agents may be releasable and/or released when the fibrous element and/or fibrous structure comprising the fibrous element is exposed to conditions of intended use. The one or more active agents in the fibrous element may be selected from the group consisting of surfactants, organic polymeric compounds, and mixtures thereof.

The fibrous elements may exhibit a diameter of less than about 300 μm, and/or less than about 75 μm, and/or less than about 50 μm, and/or less than about 25 μm, and/or less than about 10 μm, and/or less than about 5 μm, and/or less than about 1 μm. The fibrous elements may exhibit a diameter of greater than about 1 μm as measured according to the Diameter Test Method described herein. The diameter of a fibrous element may be used to control the rate of release of one or more active agents present in the fibrous element and/or the rate of loss and/or altering of the fibrous element's physical structure.

Particles may be incorporated into a fibrous water soluble product as discussed above, at a level of about 0.1 g to about 15 g. The type of particles utilized can be any that are compatible with the manufacturing system. One parameter which can contribute to the success of depositing particles according to this method is the flowability of the particles. The flowability (fₚ) of particles can be defined as the ratio of consolidation stress (cs) to unconfined yield strength (ys). The larger the fₚ, the better particles flow. Generally, it is believed that an fₚ<1 is not flowing, an fₚ>1 but less than 2 is very cohesive, an fₚ of 2 to less than 4 is considered cohesive, an fₚ of 4 to less than 10 is considered easy flowing, and an fₚ of 10 or more is considered free flowing. For the process described above, particles with an fₚ value of about 4 or more are preferred. The flowability of particles can be measured and calculated as discussed below in the Flowability Method.

The particles may be a powder, granule, agglomerate, encapsulate, microcapsule, and/or prill. The particles may be made using a number of well-known methods in the art, such as spray-drying, agglomeration, extrusion, prilling, encapsulation, pastillation, and combinations thereof. The shape of the particles can be in the form of spheres, rods, plates, tubes, squares, rectangles, discs, stars, fibers or have regular or irregular random forms. The particles may have a D50 particle size of from about 100 m to about 1600 km.

The particles may include a mixture of chemically different particles, such as: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as colored noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, these enzyme granulates may comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Combinations

Various embodiments relate to:
1. A solid detergent composition comprising:
   at least one component, according to one or more of Formulas 7-12:

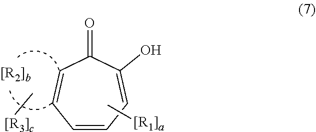

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

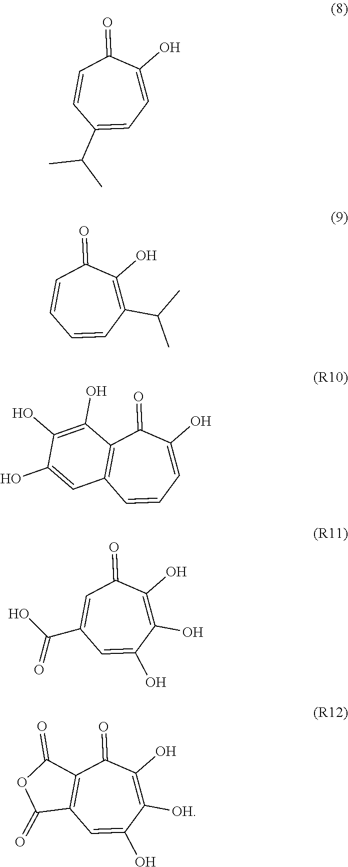

2. The solid detergent composition according to 1, wherein the at least one component according to Formula 7 is tropolone.
3. The solid detergent composition according to any of 1 or 2, wherein the at least one component according to Formula 7 is hinokitiol.
4. The solid detergent composition according to any of 1-3, wherein the at least one component has a pKa of about 8, preferably about 8 or less, more preferably about 7.5 or less, even more preferably from about 5 to about 8, even more preferably from about 5.0 to about 7.5, even more preferably from about 5.0 to about 7.25, or most preferably from about 5.0 to about 7.0.
5. The solid detergent composition according to any of 1-4, wherein the at least one component has a calcium binding efficiency of less than about 7, preferably from about 2 to about 7.0, from about 2 to about 6.8, from about 2.0 to about 6.5, from about 2.0 to about 6.0, from about 2.0 to about 5.5, from about 2.0 to about 5.0, from about 2.0 to about 4.5, from about 2.0 to about 4.5, from about 2.0 to about 4.0, more preferably from about 2.5 to about 3.5, or about 2.7 to about 3.1.
6. The solid detergent composition according to any of 1-5, wherein the at least one component has an iron binding efficiency greater than about 10.
7. The solid detergent composition according to any of 1-6, wherein the at least one component is present in an amount of from greater than about 0 to about 10% by weight of the solid detergent composition.
8. The solid detergent composition according to any of 1-7, further comprising a surfactant comprising an anionic surfactant, a nonionic surfactant, or a combination thereof, preferably an anionic surfactant comprising an alkylbenezene sulfonate, methyl ester sulfonate, alkyl ether carboxylate, alkyl sulfate, alkylalkoxylated sulfate, or a combination thereof; more preferably an alkylbenzene sulfonate.
9. The solid detergent composition according to any of 1-8, wherein the solid detergent composition is in the form of granules, beads, or fibers.
10. A single unit dose detergent comprising the solid detergent composition according to any of 1-9.
11. A method for treating a stain on a fabric, comprising:
   washing the fabric in a wash liquor comprising a solid detergent composition comprising at least one component, according one or more of Formulas 7-12:

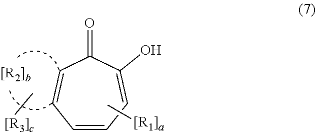

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

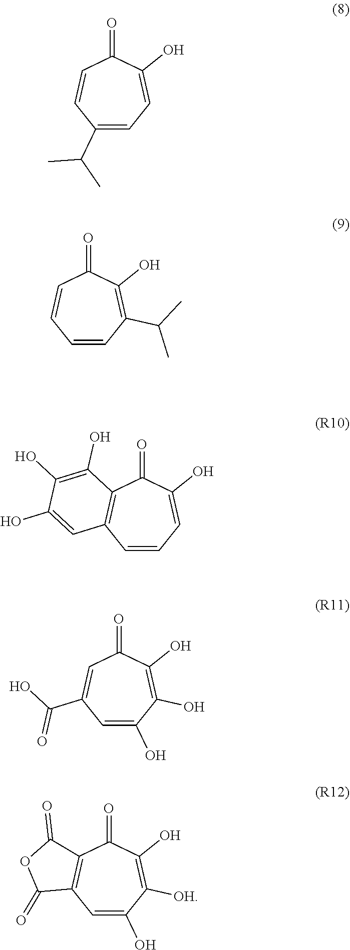 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

12. The method according to 11, wherein the at least one component according to Formula 7 is tropolone.
13. The method according to any of 11 or 12, wherein the at least one component according to Formula 7 is hinokitiol.
14. The method according to any of 11-13, wherein the at least one component has a pKa of about 8, preferably about 8 or less, more preferably about 7.5 or less, even more preferably from about 5 to about 8, even more preferably from about 5.0 to about 7.5, even more preferably from about 5.0 to about 7.25, or most preferably from about 5.0 to about 7.0.
15. The method according to any of 11-14, wherein the at least one component has a calcium binding efficiency of less than about 7, preferably from about 2 to about 7.0, from about 2 to about 6.8, from about 2.0 to about 6.5, from about 2.0 to about 6.0, from about 2.0 to about 5.5, from about 2.0 to about 5.0, from about 2.0 to about 4.5, from about 2.0 to about 4.5, from about 2.0 to about 4.0, more preferably from about 2.5 to about 3.5, or about 2.7 to about 3.1.
16. The method according to any of 11-15, wherein the at least one component has an iron binding efficiency greater than about 10, about 10 to about 20, or about 10.5 to about 14.1, or about 11 to about 12.9.
17. The method according to any of 11-16, wherein the at least one component is present in an amount of from greater than about 0 to about 10% or about 0.5 to about 9.5% by weight, or about 0.5 to about 9.5% by weight, or about 1.0 to about 9.0% by weight, or about 1.5 to about 8.5% by weight, or about 2.0 to about 8.0% by weight, or about 2.5 to about 7.5% by weight, or about 3.0 to about 7.0% by weight, or about 3.5 to about 6.5% by weight, or about 4.0 to about 6.0% by weight, or about 4.5 to about 5.5% by weight, or about 4.0 to about 5.0%, by weight of the liquid detergent composition.
18. The method according to any of 11-17, further comprising maintaining the pH of the wash liquor at less than about 10.
19. The method according to any of 11-18, wherein the solid detergent composition is delivered to the wash liquor in the form of beads or granules.
20. The method according to any of 11-19, further comprising a surfactant comprising an anionic surfactant, a nonionic surfactant, or a combination thereof, preferably an anionic surfactant comprising an alkylbenezene sulfonate, methyl ester sulfonate, alkyl ether carboxylate, alkyl sulfate, alkylalkoxylated sulfate, or a combination thereof; more preferably an alkylbenzene sulfonate
21. Use of a solid detergent composition comprising at least one component, according to one or more of Formulas 7-12, to treat a stain on a fabric,

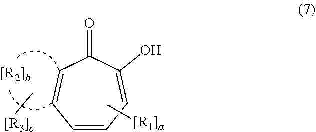

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

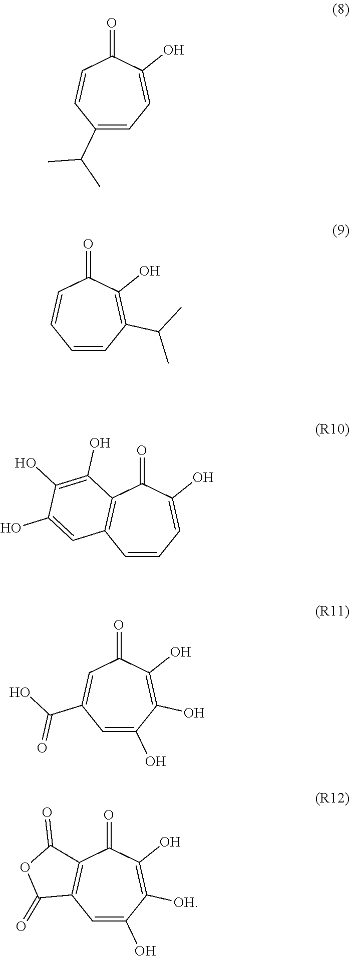 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

22. The use according to 21, wherein the at least one component according to Formula 7 is tropolone or a salt thereof.
23. The use according to any of 21 or 22, wherein the at least one component according to Formula 7 is hinokitiol or a salt thereof.
24. The use according to any of 21-23, wherein the at least one component has a pKa of about 8, preferably about 8 or less, more preferably about 7.5 or less, even more preferably from about 5 to about 8, even more preferably from about 5.0 to about 7.5, even more preferably from about 5.0 to about 7.25, or most preferably from about 5.0 to about 7.0.
25. The use according to any of 21-24, wherein the at least one component has a calcium binding efficiency of less than about 7, preferably from about 2 to about 7.0, from about 2 to about 6.8, from about 2.0 to about 6.5, from about 2.0 to about 6.0, from about 2.0 to about 5.5, from about 2.0 to about 5.0, from about 2.0 to about 4.5, from about 2.0 to about 4.5, from about 2.0 to about 4.0, more preferably from about 2.5 to about 3.5, or about 2.7 to about 3.1.
26. The use according to any of 21-25, wherein the at least one component has an iron binding efficiency greater than about 10, about 10 to about 20, or about 10.5 to about 14.1, or about 11 to about 12.9.
27. The use according to any of 21-26, wherein the at least one component is present in an amount of from greater than about 0 to about 10% or about 0.5 to about 9.5% by weight, or about 0.5 to about 9.5% by weight, or about 1.0 to about 9.0% by weight, or about 1.5 to about 8.5% by weight, or about 2.0 to about 8.0% by weight, or about 2.5 to about 7.5% by weight, or about 3.0 to about 7.0% by weight, or about 3.5 to about 6.5% by weight, or about 4.0 to about 6.0% by weight, or about 4.5 to about 5.5% by weight, or about 4.0 to about 5.0%, by weight of the liquid detergent composition.
28. The use according to any of 21-27, wherein the detergent composition further comprises a surfactant comprising an anionic surfactant, a nonionic surfactant, or a combination thereof, preferably an anionic surfactant comprising an alkylbenezene sulfonate, methyl ester sulfonate, alkyl ether carboxylate, alkyl sulfate, alkylalkoxylated sulfate, or a combination thereof; more preferably an alkylbenzene sulfonate.
29. The use according to any of 21-28, wherein the solid detergent composition is in the form of granules or beads.
30. The use according to any of 21-29, wherein a single unit dose comprises the solid detergent composition.

### Examples

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Stain Removal Index Calculation Method

Image analysis may be used to compare each stain to an unstained fabric control. Software may be used to convert images taken into standard colorimetric values and to compare these to standards based on the commonly used Macbeth Color Rendition Chart, assigning each stain a colorimetric value (Stain Level). The CIELAB color space, also referred to as L*a*b*, is a color space defined by the International Commission on Illumination (abbreviated CIE) in 1976.[a] It expresses color as three values: L* for perceptual lightness and a* and b* for the four unique colors of human vision: red, green, blue and yellow. The lightness value, L* defines black at 0 and white at 100. The a* axis is relative to the green-magenta opponent colors, with negative values toward green and positive values toward magenta. The b* axis represents the blue-yellow opponents, with negative numbers toward blue and positive toward yellow. In the following examples, various fabrics were analyzed using commercially available image analysis software for L*a*b* values. SRI values were then calculated from the L*a*b* values using the formula shown. The higher the SRI, the better the stain removal.

$$\% Stain Removal Index ( SRI ) = \frac{Δ Eb - Δ Ea}{Δ Eb} \times 100$$

in which,

$$Δ {E}_{b} = √ ( {( {L}_{c} - {L}_{b} b )}^{2} + {( {a}_{c} - {a}_{b} )}^{2} + {( {b}_{c} - {b}_{b} )}^{2} )$$

$$Δ {E}_{a} = √ ( {( {L}_{c} - {L}_{a} )}^{2} + {( {a}_{c} - {a}_{a} )}^{2} + {( {b}_{c} - {b}_{a} )}^{2} )$$

Subscript ‘b’ denotes data for the stain before washing
Subscript ‘a’ denotes data for the stain after washing
Subscript ‘c’ denotes data for the unstained fabric
   Thus, L*a*b* values are taken of the unstained fabric, of the stained fabric before washing and of the stained fabric after washing.

### Example 1: Composition in Dry Laundry for Stain Removal Benefit

Four powder Compositions were made and tested as detailed herein below. The composition for each is provided below. Table 2A provides amounts in ppm of the given component active in the wash solution. Table 2B provides amounts by weight % in the composition.

TABLE 2A

| | ppm Active in wash solution for Composition | | | |
|---|---|---|---|---|
| Component | C1-1 | C1-2 | C1-3 | C1-4 |
| Disodium 4,4′-bis[(4- | 6.69 | 6.69 | 6.69 | 6.69 |
| anilino-6-morpholino- | | | | |
| 1,3,5-triazin-2- | | | | |
| yl)amino]stilbene- | | | | |
| 2,2′-disulphonate | | | | |
| Disodium 4,4′-Bis-(2- | 1.34 | 1.34 | 1.34 | 1.34 |
| Sulfostyryl)Biphenyl | | | | |
| Carboxymethyl Cellulose | 4.23 | 4.23 | 4.23 | 4.23 |
| Citric Acid | 0.20 | 0.20 | 0.20 | 0.20 |
| HEDP | 0.00 | 25.00 | 0.00 | 0.00 |
| Hinokitiol | 0.00 | 0.00 | 25.00 | 0.00 |
| Tropolone | 0.00 | 0.00 | 0.00 | 25.00 |
| Mannanase | 0.01 | 0.01 | 0.01 | 0.01 |
| Amylase | 0.02 | 0.02 | 0.02 | 0.02 |
| Protease | 0.15 | 0.15 | 0.15 | 0.15 |
| Kaolin | 43.18 | 43.18 | 43.18 | 43.18 |
| LAS | 468.69 | 468.69 | 468.69 | 468.69 |
| Hueing Dye - Blueing | 0.91 | 0.91 | 0.91 | 0.91 |
| Agent - 1 (BA-1)^{a} | | | | |
| Sodium Carbonate | 660.52 | 660.52 | 660.52 | 660.52 |
| Sodium Sulfate | 229.99 | 229.99 | 229.99 | 229.99 |
| Sodium Chloride | 2171.15 | 2171.15 | 2171.15 | 2171.15 |
| Lipase | 0.04 | 0.04 | 0.04 | 0.04 |
| Sodium silicate | 64.00 | 64.00 | 64.00 | 64.00 |
| (SiO2/Na2O | | | | |
| ratio 1.6-2.6) | | | | |
| Sulfuric acid | 127.57 | 127.57 | 127.57 | 127.57 |
| mono-C12-14-alkyl | | | | |
| esters sodium salts | | | | |
| Zeolite | 82.43 | 82.43 | 82.43 | 82.43 |
| Water | 51.13 | 51.13 | 51.13 | 51.13 |
| Processing Aids, | 87.69 | 87.69 | 87.69 | 87.69 |
| Minors & Perfume | | | | |
| Total dosage (ppm) | 4000.00 | 4025.00 | 4025.00 | 4025.00 |

^{a}α-[4-[[[4-[2-[4-[2-[1-hydroxy-6-(phenylamino)-3-sulfo-2-naphthalenyl]diazenyl]-5-methoxy-2-methylphenyl]diazenyl]phenyl]sulfonyl]amino]phenyl]-ω-hydroxy-poly(oxy-1,2-ethanediyl), sodium salt (1:1); average degree of ethoxylation about 10.

TABLE 2B

| | % Active in Composition | | | |
|---|---|---|---|---|
| Component | C1-1 | C1-2 | C1-3 | C1-4 |
| Disodium 4,4′-bis[(4- | 0.1673 | 0.1662 | 0.1662 | 0.1662 |
| anilino-6-morpholino- | 0.0335 | 0.0333 | 0.0333 | 0.0333 |
| 1,3,5-triazin-2- | 0.1058 | 0.1051 | 0.1051 | 0.1051 |
| yl)amino]stilbene- | | | | |
| 2,2′-disulphonate | | | | |
| Disodium 4,4′-Bis-(2- | | | | |
| Sulfostyryl)Biphenyl | | | | |
| Carboxymethyl Cellulose | | | | |
| Citric Acid | 0.0050 | 0.0050 | 0.0050 | 0.0050 |
| HEDP | 0.0000 | 0.6211 | 0.0000 | 0.0000 |
| Hinokitiol | 0.0000 | 0.0000 | 0.6211 | 0.0000 |
| Tropolone | 0.0000 | 0.0000 | 0.0000 | 0.6211 |
| Mannanase | 0.0003 | 0.0002 | 0.0002 | 0.0002 |
| Amylase | 0.0005 | 0.0005 | 0.0005 | 0.0005 |
| Protease | 0.0038 | 0.0037 | 0.0037 | 0.0037 |
| Kaolin | 1.0795 | 1.0728 | 1.0728 | 1.0728 |
| LAS | 11.7173 | 11.6445 | 11.6445 | 11.6445 |
| Hueing Dye - Blueing | 0.0228 | 0.0226 | 0.0226 | 0.0226 |
| Agent - 1 (BA-1)^{a} | | | | |
| Sodium Carbonate | 16.5130 | 16.4104 | 16.4104 | 16.4104 |
| Sodium Sulfate | 5.7498 | 5.7140 | 5.7140 | 5.7140 |
| Sodium Chloride | 54.2788 | 53.9416 | 53.9416 | 53.9416 |
| Lipase | 0.0010 | 0.0010 | 0.0010 | 0.0010 |
| Sodium silicate | 1.6000 | 1.5901 | 1.5901 | 1.5901 |
| (SiO2/Na2O | | | | |
| ratio 1.6-2.6) | | | | |
| Sulfuric acid | 3.1893 | 3.1694 | 3.1694 | 3.1694 |
| mono-C12-14-alkyl | | | | |
| esters sodium salts | | | | |
| Zeolite | 2.0608 | 2.0480 | 2.0480 | 2.0480 |
| Water | 1.2783 | 1.2703 | 1.2703 | 1.2703 |
| Processing Aids, | 2.1938 | 2.1801 | 2.1801 | 2.1801 |
| Minors & Perfume | | | | |
| Total Wt. % | 100.000 | 100.000 | 100.000 | 100.000 |

^{a}α-[4-[[[4-[2-[4-[2-[1-hydroxy-6-(phenylamino)-3-sulfo-2-naphthalenyl]diazenyl]-5-methoxy-2-methylphenyl]diazenyl]phenyl]sulfonyl]amino]phenyl]-ω-hydroxy-poly(oxy-1,2-ethanediyl), sodium salt (1:1); average degree of ethoxylation about 10.

The following method was used to test the ability of the treatment compositions, as detailed in Table 3 below, to remove stains during the wash process. Each of the compositions were added separately into pots of a tergotometer. The volume of each pot was 1 L. The wash temperature was set to 27° C. Throughout the procedure, 7 gpg water was used. The products were agitated for 1 minute (300 rpm) before addition of fabrics (two internal replicates of each stain, and additional knitted cotton ballast to make the total fabric weight up to 60 g). Once the fabrics were added, the wash solution was agitated for 17 minutes (208 rpm). The wash solutions were then drained, and the fabrics were subject to a 5 minute rinse step before being drained and spun dry. This procedure was repeated a further three times to give a total of four external replicates. After the wash, the stain fabrics were dried for 30 minutes in a tumble dryer.

TABLE 3

| Treatment | Treatment Composition |
|---|---|
| 1A | 4.000 g Composition C1-1 |
| 1B | 4.025 g Composition C1-2 |
| 1C | 4.025 g Composition C1-3 |
| 1D | 4.025 g Composition C1-4 |

Table 4 summarizes stain removal testing for each treatment.

TABLE 4

| | SRI for Treatment | | | | |
|---|---|---|---|---|---|
| Stain | 1A | 1B | 1C | 1D | HSD |
| Grass | 43.3 | 48.3 | 51.7A | 52.0 A | 8.28 |
| Covergirl Makeup | 37.8 | 44.9 | 48.4A | 46.0 A | 8.03 |
| Wolf Blas Cabernet | 21.4 | 24.4 | 23.9 | 28.5 A | 6.44 |
| Sauvignon Red Wine | | | | | |

Note:
UPPER CASE letters indicate significant difference between treatments at alpha = 0.05 using Tukey's HSD.

As can be seen from Table 4, compositions 1C and 1D, containing Tropolone or Hinokitiol, show significantly improved Stain Removal vs nil chelant reference, not observed with HEDP.

### Example 2: Stain Removal Beads

Four pastille compositions (Compositions C2-1 to C2-4) and a unit dose detergent composition (Composition C2-5) were made and tested as detailed herein below. The composition for each is provided below. Table 5A provides amounts in ppm of the given component active in the wash solution. Table 5B provides amounts by weight % in the composition.

The following procedure was followed to prepare the pastilles. Polyethylene glycol 8000 was melted in an oven at 70° C. overnight. Molten polyethylene glycol was weighed into speed mixer cup. The Perfume and chelant were immediately weighed into the speed mixer cup with the molten polyethylene glycol. Speed mixer cup was placed into speed mixer and mixed for 1 minute at 3,500 rpms until homogeneous. Pastilles were formed by pouring the molten mixture after speed mixing into a siliconized rubber mould and spread using a 10-inch palette knife. The melt was then allowed to cool at room temperature to form pastilles.

TABLE 5A

| | ppm Active in wash solution for Composition | | | | |
|---|---|---|---|---|---|
| Component | C2-1 | C2-2 | C2-3 | C2-4 | C2-5 |
| PEG8000 | 1511.479 | 1453.500 | 1476.756 | 1476.756 | 0.00 |
| Perfume | 103.522 | 103.522 | 103.522 | 103.522 | 0.00 |
| HEDP (Aquacid 105EX | 0.000 | 34.723 | 0.000 | 0.000 | 0.00 |
| (supplied by Aquapharm)) | | | | | |
| Tropolone | 0.000 | 0.000 | 34.723 | 0.000 | 0.00 |
| Hinokitiol | 0.000 | 0.000 | 0.000 | 34.723 | 0.00 |
| Deionised Water | 0.00 | 0.00 | 0.00 | 0.00 | 51.944 |
| Citric Acid | 0.00 | 0.00 | 0.00 | 0.00 | 10.872 |
| 1,2 Propylene Glycol | 0.00 | 0.00 | 0.00 | 0.00 | 182.852 |
| Monoethanolamine | 0.00 | 0.00 | 0.00 | 0.00 | 89.481 |
| Glycerine | 0.00 | 0.00 | 0.00 | 0.00 | 74.206 |
| Potassium Sulfite | 0.00 | 0.00 | 0.00 | 0.00 | 6.186 |
| C12-14 Alcohol Ethoxylate AE7 | 0.00 | 0.00 | 0.00 | 0.00 | 53.832 |
| HLAS | 0.00 | 0.00 | 0.00 | 0.00 | 382.501 |
| Disodium 4,4′-Bis-(2- | 0.00 | 0.00 | 0.00 | 0.00 | 4.756 |
| Sulfostyryl)Biphenyl | | | | | |
| C12-C18 Fatty Acid | 0.00 | 0.00 | 0.00 | 0.00 | 25.088 |
| Alkyl Ethoxy Sulfate C24E3S | 0.00 | 0.00 | 0.00 | 0.00 | 196.905 |
| Lutensit Z 96 (Trans-sulfonated | 0.00 | 0.00 | 0.00 | 0.00 | 28.995 |
| Polymer supplied by BASF) | | | | | |
| Sokalan HP20 (Modified | 0.00 | 0.00 | 0.00 | 0.00 | 24.647 |
| Polyethylene Imine supplied | | | | | |
| by BASF) | | | | | |
| Magnesium Chloride | 0.00 | 0.00 | 0.00 | 0.00 | 4.982 |
| Sokalan PG101(PEG Vac | 0.00 | 0.00 | 0.00 | 0.00 | 39.858 |
| Polymer supplied by BASF | | | | | |
| AF8017 Antifoam (Silicone | 0.00 | 0.00 | 0.00 | 0.00 | 4.680 |
| Antifoam Supplied by Dow) | | | | | |
| Protease | 0.00 | 0.00 | 0.00 | 0.00 | 1.022 |
| Amylase 1 | 0.00 | 0.00 | 0.00 | 0.00 | 0.147 |
| Amylase 2 | 0.00 | 0.00 | 0.00 | 0.00 | 0.037 |
| Mannanase | 0.00 | 0.00 | 0.00 | 0.00 | 0.058 |
| Phosphodiesterase | 0.00 | 0.00 | 0.00 | 0.00 | 0.184 |
| Hydrogenated Castor Oil | 0.00 | 0.00 | 0.00 | 0.00 | 1.404 |
| Processing Aids, Minors, | 0.00 | 23.256 | 0.00 | 0.00 | 380.563 |
| Aesthetic Dyes and Perfume | | | | | |
| Total ppm | 1615 | 1615 | 1615 | 1615 | 1565 |

TABLE 5B

| | % Active in Composition | | | | |
|---|---|---|---|---|---|
| Component | C2-1 | C2-2 | C2-3 | C2-4 | C2-5 |
| PEG8000 | 93.5900 | 89.9999 | 91.4399 | 91.4399 | 0.0000 |
| Perfume | 6.4100 | 6.4100 | 6.4100 | 6.4100 | 0.0000 |
| HEDP (Aquacid 105EX | 0.0000 | 2.1500 | 0.0000 | 0.0000 | 0.0000 |
| (supplied by Aquapharm)) | | | | | |
| Tropolone | 0.0000 | 0.0000 | 2.1500 | 0.0000 | 0.0000 |
| Hinokitiol | 0.0000 | 0.0000 | 0.0000 | 2.1500 | 0.0000 |
| Deionised Water | 0.0000 | 0.0000 | 0.0000 | 0.0000 | 3.3187 |
| Citric Acid | 0.0000 | 0.0000 | 0.0000 | 0.0000 | 0.6946 |
| 1,2 Propylene Glycol | 0.0000 | 0.0000 | 0.0000 | 0.0000 | 12.066 |
| Monoethanolamine | 0.0000 | 0.0000 | 0.0000 | 0.0000 | 5.333 |
| Glycerine | 0.0000 | 0.0000 | 0.0000 | 0.0000 | 4.7410 |
| Potassium Sulfite | 0.0000 | 0.0000 | 0.0000 | 0.0000 | 0.3952 |
| C12-14 Alcohol Ethoxylate AE7 | 0.0000 | 0.0000 | 0.0000 | 0.0000 | 3.4393 |
| HLAS | 0.0000 | 0.0000 | 0.0000 | 0.0000 | 24.4378 |
| Disodium 4,4′-Bis-(2- | 0.0000 | 0.0000 | 0.0000 | 0.0000 | 0.3039 |
| Sulfostyryl)Biphenyl | | | | | |
| C12-C18 Fatty Acid | 0.0000 | 0.0000 | 0.0000 | 0.0000 | 1.6029 |
| Alkyl Ethoxy Sulfate C24E3S | 0.0000 | 0.0000 | 0.0000 | 0.0000 | 12.5802 |
| Lutensit Z 96 (Trans-sulfonated | 0.0000 | 0.0000 | 0.0000 | 0.0000 | 1.8525 |
| Polymer supplied by BASF) | | | | | |
| Sokalan HP20 (Modified | 0.0000 | 0.0000 | 0.0000 | 0.0000 | 1.5747 |
| Polyethylene Imine supplied | | | | | |
| by BASF) | | | | | |
| Magnesium Chloride | 0.0000 | 0.0000 | 0.0000 | 0.0000 | 0.3183 |
| Sokalan PG101(PEG Vac | 0.0000 | 0.0000 | 0.0000 | 0.0000 | 2.5465 |
| Polymer supplied by BASF | | | | | |
| AF8017 Antifoam (Silicone | 0.0000 | 0.0000 | 0.0000 | 0.0000 | 0.2990 |
| Antifoam Supplied by Dow) | | | | | |
| Protease | 0.0000 | 0.0000 | 0.0000 | 0.0000 | 0.0653 |
| Amylase 1 | 0.0000 | 0.0000 | 0.0000 | 0.0000 | 0.0094 |
| Amylase 2 | 0.0000 | 0.0000 | 0.0000 | 0.0000 | 0.0024 |
| Mannanase | 0.0000 | 0.0000 | 0.0000 | 0.0000 | 0.0037 |
| Phosphodiesterase | 0.0000 | 0.0000 | 0.0000 | 0.0000 | 0.0118 |
| Hydrogenated Castor Oil | 0.0000 | 0.0000 | 0.0000 | 0.0000 | 0.0897 |
| Processing Aids, Minors, | 0.0000 | 1.4400 | 0.0000 | 0.0000 | 24.3140 |
| Aesthetic Dyes and Perfume | | | | | |
| Total Wt. % | 100.0000 | 100.0000 | 100.0000 | 100.0000 | 100.0000 |

The following method was used to test the ability of the treatment compositions, as detailed in Table 6 below, to remove stains in a washing process. Each of the compositions were added separately into pots of a tergotometer. The volume of each pot was 1 L. The wash temperature was set to 35° C. Throughout the procedure, 21 gpg water was used. The products were agitated for 1 minute (400 rpm) before addition of fabrics (two internal replicates of each stain, 13×6 cm² SBL2004 (supplied by WFK) and additional 6 cm² knitted cotton ballast squares to make the total fabric weight up to 60 g). Once the fabrics were added, the wash solution was agitated for 30 minutes (300 rpm). The wash solutions were then drained and the fabrics were twice subjected to a 5 minute rinse step before being drained and spun dry. This procedure was repeated a further three times to give a total of four external replicates. After the wash, the stain fabrics were dried for 30 minutes in a tumble dryer.

TABLE 6

| Treatment | Treatment Composition |
|---|---|
| 2A | 1.565 g Composition C2-5 + 1.615 g Composition C2-1 |
| 2B | 1.565 g Composition C2-5 + 1.615 g Composition |
| | C2-2 + 0.32 ml 1M NaOH (added to maintain |
| | consistent pH across all compositions) |
| 2C | 1.565 g Composition C2-5 + 1.615 g Composition C2-3 |
| 2D | 1.565 g Composition C2-5 + 1.615 g Composition C2-4 |

Table 7 summarizes stain removal testing for each treatment.

TABLE 7

| | SRI for Treatment | | | | |
|---|---|---|---|---|---|
| Stain | 2A | 2B | 2C | 2D | HSD |
| Discriminating Sebum | 61.2 B | 55.1 | 63.8 B | 61.8 B | 4.91 |
| Dye Bacon Grease | 93.7 B | 89.5 | 92.5 B | 92.9 B | 2.79 |
| Lipton Tea | 8.4 | 19.2 A | 22.9 A | 25.9 AB | 4.38 |

Note:
UPPER CASE letters indicate significant difference between treatments at alpha = 0.05 using Tukey's HSD.

As can be seen from Table 7, Examples 2C & 2D, containing tropolone and hinokitiol, show improved stain removal on tea stains (vs nil chelant (2A) or HEDP (2B)) while avoiding the negative effects of HEDP on discriminating sebum and bacon grease.

Solid free-flowing particulate laundry detergent composition examples:

| Ingredient | Amount (in wt %) |
|---|---|
| Anionic detersive surfactant (such as alkyl benzene | from 8 wt % to 15 wt % |
| sulphonate, alkyl ethoxylated sulphate and mixtures thereof) | |
| Non-ionic detersive surfactant (such as alkyl ethoxylated | from 0.1 wt % to 4 wt % |
| alcohol) | |
| Cationic detersive surfactant (such as quaternary | from 0 wt % to 4 wt % |
| ammonium compounds) | |
| Other detersive surfactant (such as zwiterionic detersive | from 0 wt % to 4 wt % |
| surfactants, amphoteric surfactants and mixtures thereof) | |
| Carboxylate polymer (such as co-polymers of maleic acid | from 0.1 wt % to 4 wt % |
| and acrylic acid and/or carboxylate polymers comprising | |
| ether moieties and sulfonate moieties) | |
| Polyethylene glycol polymer (such as a polyethylene glycol | from 0 wt % to 4 wt % |
| polymer comprising polyvinyl acetate side chains) | |
| Polyester soil release polymer (such as Repel-o-tex and/or | from 0 wt % to 2 wt % |
| Texcare polymers) | |
| Cellulosic polymer (such as carboxymethyl cellulose, methyl | from 0.5 wt % to 2 wt % |
| cellulose and combinations thereof) | |
| Other polymer (such as care polymers) | from 0 wt % to 4 wt % |
| Zeolite builder and phosphate builder (such as zeolite 4A | from 0 wt % to 4 wt % |
| and/or sodium tripolyphosphate) | |
| Other co-builder (such as sodium citrate and/or citric acid) | from 0 wt % to 3 wt % |
| Carbonate salt (such as sodium carbonate and/or sodium | from 0 wt % to 20 wt % |
| bicarbonate) | |
| Silicate salt (such as sodium silicate) | from 0 wt % to 10 wt % |
| Filler (such as sodium sulphate and/or bio-fillers) | from 10 wt % to 70 wt % |
| Source of hydrogen peroxide (such as sodium percarbonate) | from 0 wt % to 20 wt % |
| Bleach activator (such as tetraacetylethylene diamine | from 0 wt % to 8 wt % |
| (TAED) and/or nonanoyloxybenzenesulphonate (NOBS)) | |
| Bleach catalyst (such as oxaziridinium-based bleach catalyst | from 0 wt % to 0.1 wt % |
| and/or transition metal bleach catalyst) | |
| Other bleach (such as reducing bleach and/or pre-formed | from 0 wt % to 10 wt % |
| peracid) | |
| Photobleach (such as zinc and/or aluminium sulphonated | from 0 wt % to 0.1 wt % |
| phthalocyanine) | |
| Chelant (such as one or more of Formulas 7-12 | from 0.2 wt % to 5 wt % |
| Hueing agent (such as direct violet 9, 66, 99, acid red 50, | from 0 wt % to 1 wt % |
| solvent violet 13 and any combination thereof) | |
| Brightener (C.I. fluorescent brightener 260 or C.I. | from 0.1 wt % to 0.4 wt % |
| fluorescent brightener 351) | |
| Protease (such as Savinase, Savinase Ultra, Purafect, FN3, | from 0.1 wt % to 0.4 wt % |
| FN4 and any combination thereof) | |
| Amylase (such as Termamyl, Termamyl ultra, Natalase, | from 0 wt % to 0.2 wt % |
| Optisize, Stainzyme, Stainzyme Plus and any combination | |
| thereof) | |
| Cellulase (such as Carezyme and/or Celluclean) | from 0 wt % to 0.2 wt % |
| Lipase (such as Lipex, Lipolex, Lipoclean and any | from 0 wt % to 1 wt % |
| combination thereof) | |
| Other enzyme (such as xyloglucanase, cutinase, pectate | from 0 wt % to 2 wt % |
| lyase, mannanase, bleaching enzyme) | |
| Fabric softener (such as montmorillonite clay and/or | from 0 wt % to 15 wt % |
| polydimethylsiloxane (PDMS)) | |
| Flocculant (such as polyethylene oxide) | from 0 wt % to 1 wt % |
| Suds suppressor (such as silicone and/or fatty acid) | from 0 wt % to 4 wt % |
| Perfume (such as perfume microcapsule, spray-on perfume, | from 0.1 wt % to 1 wt % |
| starch encapsulated perfume accords, perfume loaded zeolite, | |
| and any combination thereof) | |
| Aesthetics (such as coloured soap rings and/or coloured | from 0 wt % to 1 wt % |
| speckles/noodles) | |
| Miscellaneous | balance to 100 wt % |

### FURTHER DEFINITIONS AND CROSS-REFERENCES

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid detergent composition comprising:
at least one component, according to one or more of Formulas 7-12: 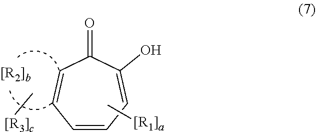
wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

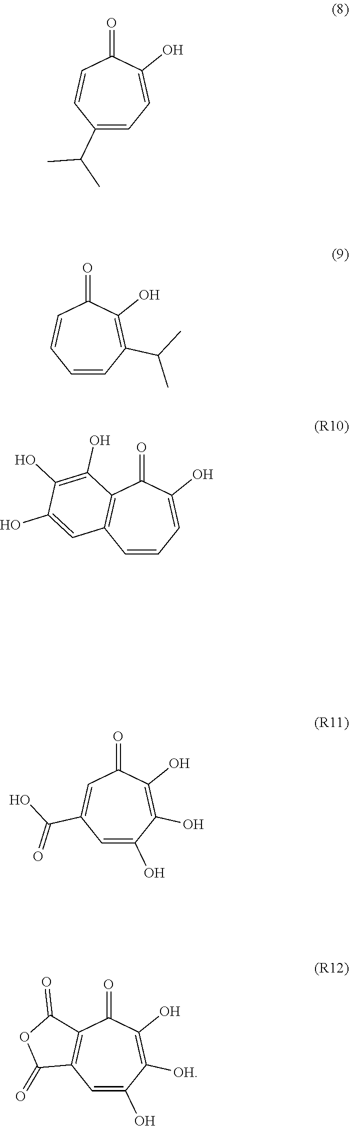 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

2. The solid detergent composition according to claim 1, wherein the at least one component according to Formula 7 is tropolone.

3. The solid detergent composition according to claim 1, wherein the at least one component according to Formula 7 is hinokitiol.

4. The solid detergent composition according to claim 1, wherein the at least one component has a pKa of less than about 8.

5. The solid detergent composition according to claim 1, wherein the at least one component has a calcium binding efficiency of less than about 7.

6. The solid detergent composition according to claim 1, wherein the at least one component has an iron binding efficiency greater than about 10.

7. The solid detergent composition according to claim 1, wherein the at least one component is present in an amount of from greater than about 0 to about 10% by weight of the solid detergent composition.

8. The solid detergent composition according to claim 1, further comprising a surfactant comprising an anionic surfactant, a nonionic surfactant, or a combination thereof.

9. The solid detergent composition according to claim 1, wherein the solid detergent composition is in the form of granules or beads.

10. A single unit dose detergent comprising the solid detergent composition according to claim 1.

11. A method for treating a stain on a fabric, comprising:
washing the fabric in a wash liquor comprising a solid detergent composition comprising at least one component, according to one or more of Formulas 7-12: 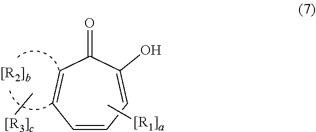
wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

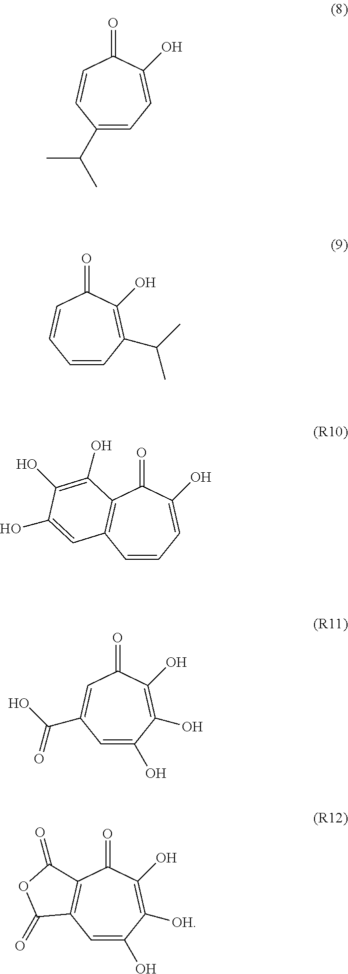 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

12. The method according to claim 11, wherein the at least one component according to Formula 7 is tropolone.

13. The method according to claim 11, wherein the at least one component according to Formula 7 is hinokitiol.

14. The method according to claim 11, wherein the at least one component has a pKa of less than about 8.

15. The method according to claim 11, wherein the at least one component has a calcium binding efficiency of less than about 7.

16. The method according to claim 11, wherein the at least one component has an iron binding efficiency greater than about 10.

17. The method according to claim 11, wherein the at least one component is present in an amount of from greater than about 0 to about 10% by weight of the solid detergent composition.

18. The method according to claim 11, further comprising maintaining the pH of the wash liquor at less than about 10.

19. The method according to claim 11, wherein the solid detergent composition is delivered to the wash liquor in the form of beads or granules.

20. A method for pre-treating a stain on a fabric, comprising:
applying a solid detergent composition to the fabric, the solid detergent composition comprising at least one component, according to one or more of Formulas 7-12: 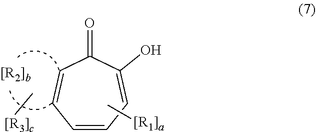
wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof; 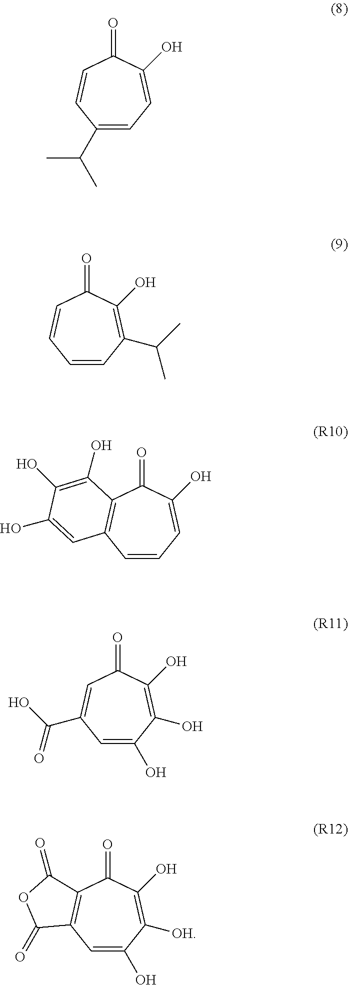 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]
